(19) United States
(12) Patent Application Publication
(10) Pub. No.: US 2022/0383212 A1
(43) Pub. Date: Dec. 1, 2022

(54) PRODUCTION SIMULATION DEVICE

(71) Applicant: Hitachi, Ltd., Tokyo (JP)

(72) Inventor: Satoshi NAGAHARA, Tokyo (JP)

(21) Appl. No.: 17/770,796

(22) PCT Filed: Sep. 1, 2020
(86) PCT No.: PCT/JP2020/033155

§ 371 Date: Apr. 21, 2022

(30) Foreign Application Priority Data
Nov. 19, 2019 (JP) 2019-209009

(51) Int. Cl. G06Q 10/06; G05B 15/02

(52) U.S. Cl. CPC G06Q 10/063; G05B 15/02

(57) ABSTRACT

A production simulation device includes one or more processors and one or more storage devices. The one or more storage devices store production performance information including information on a performance start time and a performance completion time of each process of a production job, and a simulation model including information on a process time of each process, a production resource group that is allocatable to each process, an operating time of each production resource of each production resource group, and a production control rule of the production line. The one or more processors execute a simulation using the production performance information and the simulation model, and calculate a simulation error by comparing the production performance information with a result of the simulation.

### INCORPORATION BY REFERENCE

The present application claims priority from Japanese Patent Application No. 2019-209009 filed on Nov. 19, 2019, and contents of which are incorporated into the present application by reference.

### TECHNICAL FIELD

The present invention relates to a production simulation.

### BACKGROUND ART

A production simulation is a method for estimating a future production progress in a factory or the like, and is useful for planning a production plan, planning a measure at a time of occurrence of a production trouble, and the like. The production simulation requires process information that defines processing time and required production resources (apparatuses, operators, or the like) in each process of each item, production resource information that defines the number of production resources, a future operating time, or the like, and production control rule information that determines a construction start order of goods and the used production resources in each process.

Here, in order to effectively utilize the production simulation, it is important to improve accuracy of the production simulation, and in order to improve the accuracy of the production simulation, it is important to improve accuracy of each piece of information described above. For example, when there is a deviation between a process time used in a simulation and an actual process time, an error of the simulation with respect to a production performance becomes large.

However, it is difficult to accurately define all pieces of information manually, especially in multi-product production or the like. On the other hand, there is a method of defining various types of information based on past production performance data. For example, as in PTL 1, there is a method of creating reference data of the number of apparatuses and the process time based on the production performance data.

### CITATION LIST

### Patent Literature

PTL 1: JP-A-2008-234526

### SUMMARY OF INVENTION

### Technical Problem

PTL 1 describes a method of creating information such as the number of apparatuses and the process time based on the production performance data and executing the production simulation using the information. However, assuming that the production simulation is used for planing the production plan, it is not enough to create each piece of information, and it is necessary to evaluate the error of the simulation itself using these pieces of information. When the error is large, it is necessary to identify an error factor and take a measure to solve the error factor.

Here, the production simulation is characterized in that the above process time information, production resource information, production control rule information, and the like are intertwined with one another in a complicated manner. For example, when the process time in a certain process group deviates from an actual state, an arrival time of the goods to a subsequent process in the process group deviates from the actual state. If the construction start order in the subsequent process is determined according to the arrival order of the goods, the deviation of the arrival time of the goods leads to the deviation of the construction start order.

As described above, the production simulation has a property that an error in a certain process propagates to another process, and this property makes it difficult to identify the error factor of the production simulation. From the above, it is important to identify a main cause of a simulation error in order to improve the accuracy of the production simulation.

### Solution to Problem

In order to solve the above problems, an aspect of the present disclosure provides a production simulation device configured to estimate a progress of a process in a production line. The production simulation device includes one or more processors and one or more storage devices. The one or more storage devices are configured to store production performance information including information on a performance start time and a performance completion time of each process of a production job, and a simulation model including information on a process time of each process, a production resource group that is allocatable to each process, an operating time of each production resource of each production resource group, and a production control rule of the production line. The one or more processors are configured to execute a simulation using the production performance information and the simulation model, and calculate a simulation error by comparing the production performance information with a result of the simulation.

### Advantageous Effect

According to the aspect of the present disclosure, a highly accurate production simulation can be implemented.

### BRIEF DESCRIPTION OF DRAWINGS

FIG. 1A is a functional block diagram of a production simulation device.

FIG. 1B is a hardware and software configuration diagram of the production simulation device.

FIG. 2 is a schematic diagram of a production performance data table.

FIG. 3 is a schematic diagram of a production process data table.

FIG. 4 is a schematic diagram of an apparatus data table.

FIG. 5 is a schematic diagram of an operator data table.

FIG. 6 is a schematic diagram of a construction start order rule data table.

FIG. 7 is a schematic diagram of an apparatus allocation rule data table.

FIG. 8 is a schematic diagram of an operator allocation rule data table.

FIG. 9 is a schematic diagram of a simulation result data table.

FIG. 10 is a processing flowchart of a control unit of the production simulation device.

FIG. 11A is a schematic diagram illustrating an example of a display screen.

FIG. 11B is a schematic diagram illustrating an example of the display screen.

FIG. 12 is a schematic diagram illustrating an example of an embodiment of a production simulation system.

### DESCRIPTION OF EMBODIMENTS

Hereinafter, an embodiment will be described with reference to the accompanying drawings. It should be noted that the present embodiment is merely an example for implementing the invention, and does not limit the technical scope of the invention.

When a production simulation is used for planing a production plan, it is important to improve accuracy of the production simulation. On the other hand, there is a method of deriving information necessary for simulation of a processing time of each process or the like from production performance data. However, when an error is large in the simulation using the derived information, it is necessary to identify an error factor and take a measure to solve the error factor.

The production simulation has a property that process information, production resource information, production control rule information, and the like are intertwined with one another in a complicated manner and the error in a certain process propagates to other processes. In the production simulation having such a property, it is required to identify a main cause of the error. A system described below calculates a simulation error by comparing a production performance with a simulation result. Accordingly, the error factor can be identified, and a highly accurate production simulation can be implemented. Accordingly, feasibility and optimality of the production plan can be improved by planning the production plan using the production simulation.

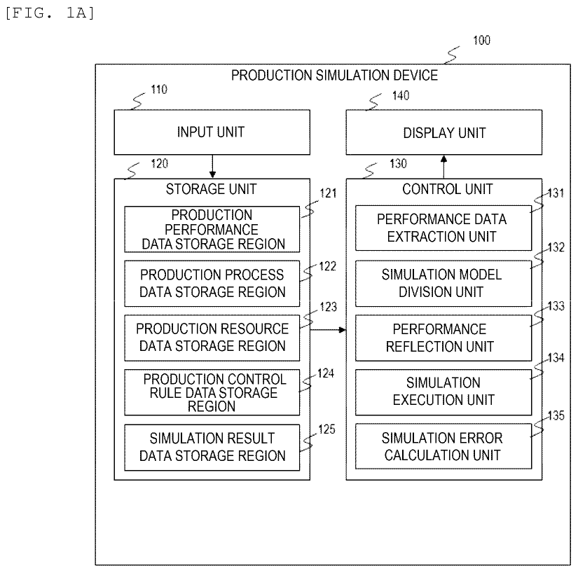

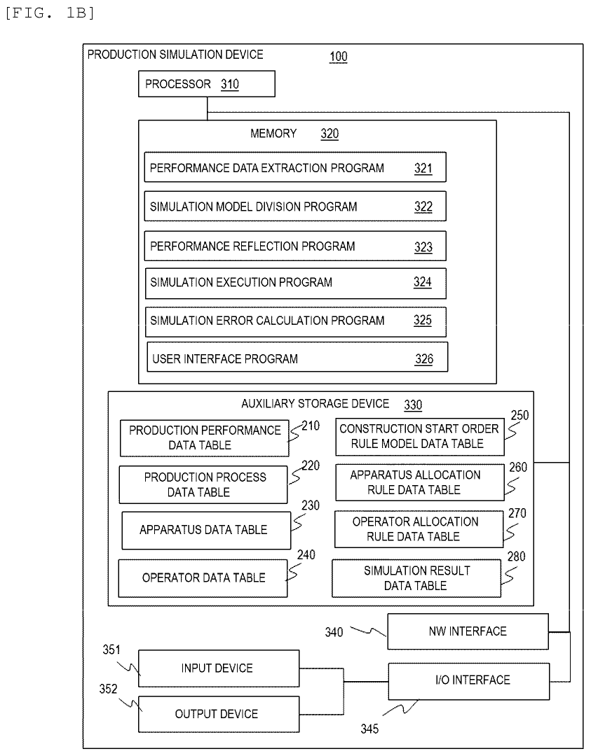

FIG. 1A is a functional block diagram of a production simulation device 100. As illustrated, the production simulation device 100 includes an input unit 110, a storage unit 120, a control unit 130, and a display unit 140.

The input unit 110 receives input of various types of information from an outside of the production simulation device 100. The display unit 140 displays information in the storage unit on a screen. The storage unit 120 includes a production performance data storage region 121, a production process data storage region 122, a production resource data storage region 123, a production control rule data storage region 124, and a simulation result data storage region 125.

The production performance data storage region 121 stores information for specifying past processing performances in a production process. The production process data storage region 122 stores information for identifying information such as a process time of each process. The production resource data storage region 123 stores information for identifying an operating time of a production resource such as an apparatus or an operator. The production control rule data storage region 124 stores information for identifying a production control rule such as a construction start order rule. The simulation result data storage region 125 stores information for identifying a simulation result.

The control unit 130 includes a performance data extraction unit 131, a simulation model division unit 132, a performance reflection unit 133, a simulation execution unit 134, and a simulation error calculation unit 135.

FIG. 1B illustrates a hardware and software configuration example of the production simulation device 100. In the example in FIG. 1B, the production simulation device 100 is implemented by a single computer. The production simulation device 100 includes a processor 310, a memory 320, an auxiliary storage device 330, a network (NW) interface 340, an I/O interface 345, an input device 351, and an output device 352. The above components are connected to one another by a bus. The memory 320, the auxiliary storage device 330, or a combination thereof is a storage device including a non-transitory storage medium, and may correspond to the storage unit 120.

The memory 320 is implemented by, for example, a semiconductor memory, and is mainly used to store programs and data. The programs stored in the memory 320 includes a performance data extraction program 321, a simulation model division program 322, a performance reflection program 323, a simulation execution program 324, a simulation error calculation program 325, and a user interface program 326 in addition to an operating system (not illustrated).

The processor 310 executes various types of processing according to the programs stored in the memory 320. When the processor 310 operates according to the programs, various functional units are implemented. For example, the processor 310 functions as the control unit 130, specifically, the performance data extraction unit 131, the simulation model division unit 132, the performance reflection unit 133, the simulation execution unit 134, and the simulation error calculation unit 135 according to the above programs. The processor 310 operates according to the user interface program 326 and functions as the input unit 110 and the display unit 140.

The auxiliary storage device 330 is implemented by, for example, a large-capacity storage device such as a hard disk drive or a solid-state drive, and is used to store the programs and data for a long period of time. The auxiliary storage device 330 stores a production performance data table 210, a production process data table 220, an apparatus data table 230, an operator data table 240, a construction start order rule model data table 250, an apparatus allocation rule data table 260, an operator allocation rule data table 270, and a simulation result data table 280.

The production performance data table 210 is an example of information stored in the production performance data storage region 121. The production process data table 220 is an example of information stored in the production process data storage region 122. The apparatus data table 230 and the operator data table 240 are examples of information stored in the production resource data storage region 123.

The construction start order rule model data table 250, the apparatus allocation rule data table 260, and the operator allocation rule data table 270 are examples of information stored in the production control rule data storage region 124. The simulation result data table 280 is an example of information stored in the simulation result data storage region 125.

For convenience of description, the programs 321 to 326 are stored in the memory 320, and the tables 210, 220, 230, 240, 250, 260, 270, and 280 are stored in the auxiliary storage device 330. However, a data storage location of the production simulation device 100 is not limited. For example, the programs and the data that are stored in the auxiliary storage device 330 are loaded into the memory 320 at a time of activation or when necessary, and the processor 310 executes the programs, whereby the various types of processing of the production simulation device 100 are executed. Therefore, in the following, a subject of processing executed by the functional unit, the program, the processor 310, or the production simulation device 100 can be replaced.

The network interface 340 is an interface for connection to a network. The production simulation device 100 communicates with other devices in the system via the network interface 340. The input device 351 is a hardware device for a user to input instructions, information, and the like, and includes, for example, a keyboard and a pointing device. The output device 352 is a hardware device that displays various images for input and output, and is, for example, a display device.

The production simulation device 100 includes one or more processors and one or more storage devices. Each processor can include a single or a plurality of arithmetic units or processing cores. The processor can be implemented as, for example, a central processing unit, a microprocessor, a microcomputer, a microcontroller, a digital signal processor, a state machine, a logic circuit, a graphics processing device, a chip-on system, and/or any device that operates a signal based on a control instruction.

A function of the production simulation device 100 may be implemented by distributed processing executed by a computer system including a plurality of computers. The plurality of computers execute the processing in cooperation with each other by communicating with each other via a network.

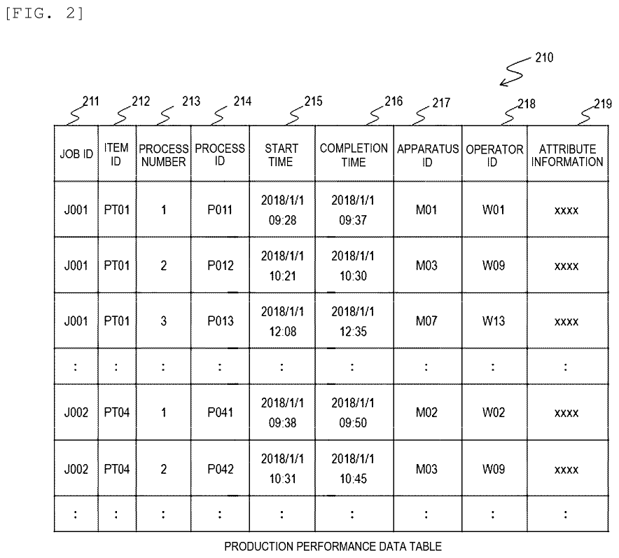

FIG. 2 shows a configuration example of the production performance data table 210. The production performance data table 210 includes a job ID column 211, an item ID column 212, a process number column 213, a process ID column 214, a start time column 215, a completion time column 216, an apparatus ID column 217, an operator ID column 218, and an attribute information column 219. Each row of the production performance data table 210 is specified according to a job ID and a process number.

The job ID column 211 stores information for specifying each production job (also simply referred to as a job). The job represents an object to be processed in the production process. The item ID column 212 stores information for identifying an item of the job. The process number column 213 stores information for identifying an order of processes in which the item is to be processed. The process ID column 214 stores information for identifying the process of the process number of the item.

In the present embodiment, it is assumed that a process ID is unique to a combination of an item ID and the process number, and the combination of the item ID and the process number is unique to the process ID. Each process in each job is referred to as a task. That is, one row in the production performance data table 210 corresponds to one task.

The start time column 215 and the completion time column 216 store information of a performance start time and a performance completion time of the process, respectively. The apparatus ID column 217 and the operator ID column 218 store information for identifying the apparatus and the operator that process the process of the job, respectively. The attribute information column 219 stores attribute information related to the job and the process, for example, a type name, a size, and a delivery date of the job, a completion request time of the process of the job, and the like.

FIG. 3 shows a configuration example of the production process data table 220. The production process data table 220 includes a process ID column 221, a process time column 222, one or a plurality of allocatable apparatus ID columns 223, and one or a plurality of allocatable operator ID columns 224.

Each row of the production process data table 220 is identified according to the process ID. The process ID column 221 stores information for specifying a process. The process time column 222 stores information indicating a time required for the processing of the process. The allocatable apparatus ID column 223 and the allocatable operator ID column 224 store information for specifying the apparatus and the operator that are capable of processing the process, respectively.

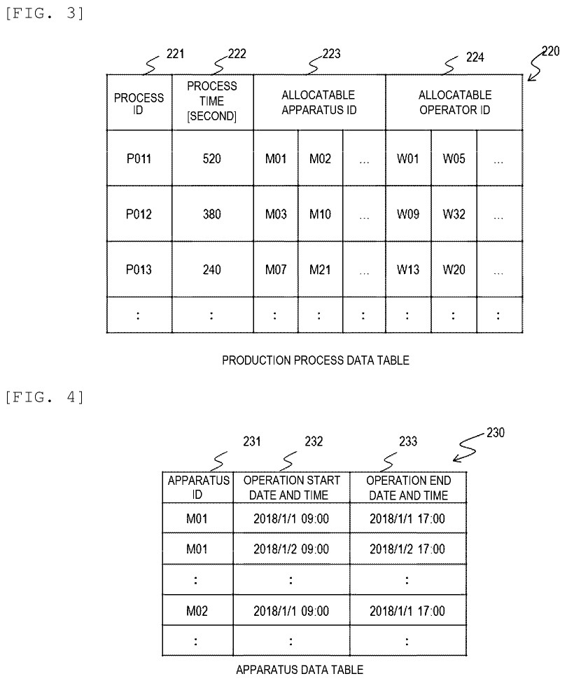

FIG. 4 shows a configuration example of the apparatus data table 230. The apparatus data table 230 includes an apparatus ID column 231, an operation start time column 232, and an operation end time column 233. The apparatus ID column 231 stores information for specifying the apparatus. The operation start time column 232 and the operation end time column 233 respectively store times at which the apparatus starts and ends the operation.

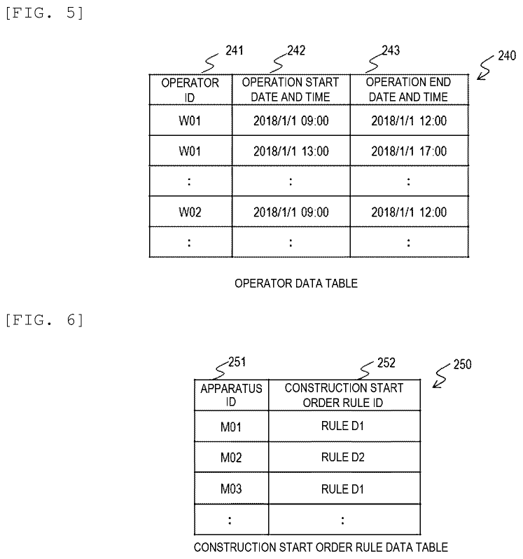

FIG. 5 shows a configuration example of the operator data table 240. The operator data table 240 includes an operator ID column 241, an operation start time column 242, and an operation end time column 243. The operator ID column 241 stores information for specifying the operator. The operation start time column 242 and the operation end time column 243 respectively store times at which the operator starts and ends the operation.

As shown in FIGS. 6, 7, and 8, the construction start order rule data table, the apparatus allocation rule data table, and the operator allocation rule data table are stored.

FIG. 6 shows a configuration example of the construction start order rule model data table 250. The construction start order rule model data table 250 includes an apparatus ID column 251 and a construction start order rule ID column 252. The apparatus ID column 251 stores information for specifying the apparatus. The construction start order rule ID column 252 stores information for specifying the construction start order rule in the apparatus. The construction start order rule is a rule for determining the next job to be processed from jobs waiting to be processed in a certain apparatus, and typical rules include a first-in first-out rule, a delivery date order rule, and the like.

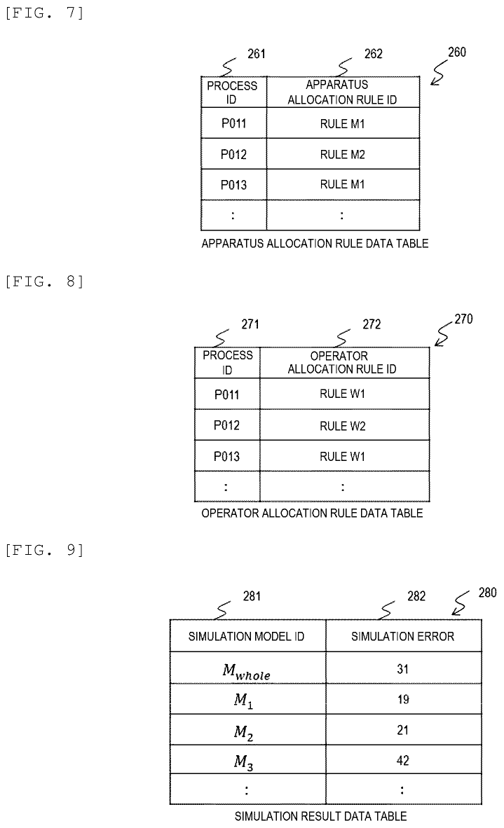

FIG. 7 shows a configuration example of the apparatus allocation rule data table 260. The apparatus allocation rule data table 260 includes a process ID column 261 and an apparatus allocation rule ID column 262. The process ID column 261 stores information for specifying the process. The apparatus allocation rule ID column 262 stores information for specifying an apparatus allocation rule in the process. The apparatus allocation rule is a rule for determining which apparatus is to be assigned to each task corresponding to one process when a plurality of allocatable apparatuses are defined for the process on the production process data table 220.

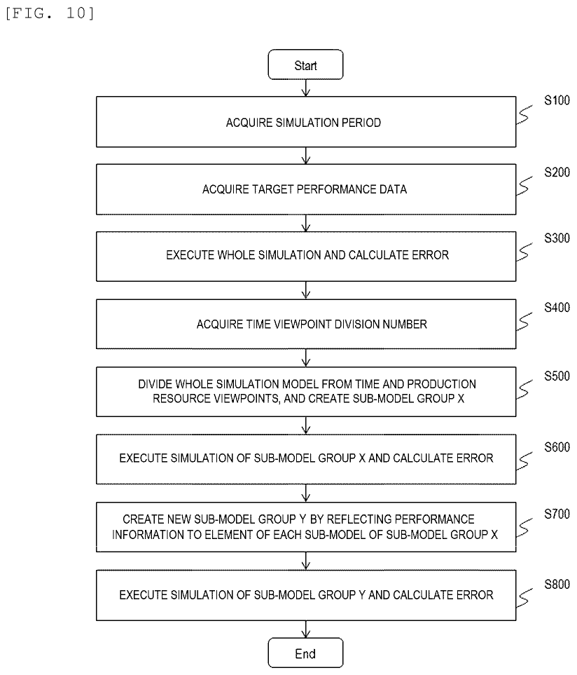

FIG. 8 shows a configuration example of the operator allocation rule data table 270. The operator allocation rule data table 270 includes a process ID column 271 and an operator allocation rule ID column 272. The process ID column 271 stores information for specifying the process. The operator allocation rule ID column 272 stores information for specifying an operator allocation rule in the process. The operator allocation rule is a rule for determining which operator is to be assigned to each task corresponding to one process when a plurality of allocatable operators are defined for the process on the production process data table 220.

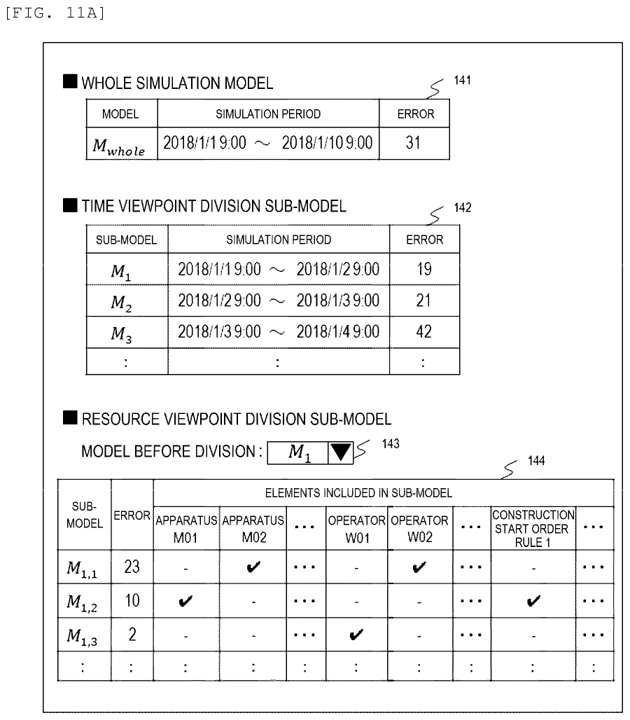

FIG. 9 shows a configuration example of the simulation result data table 280. The simulation result data table 280 includes a simulation model ID column 281 and a simulation error column 282. The simulation model ID column 281 stores information for specifying a simulation model. The simulation error column 282 stores information indicating an error of the simulation executed by the simulation model.

FIG. 10 shows a series of processing flowcharts in the control unit 130. Hereinafter, the processing according to the present embodiment will be described with reference to the present flowchart.

Steps S100 to S200 are processing executed by the performance data extraction unit 131. First, in step S100, the performance data extraction unit 131 acquires a start time and an end time of a simulation period input by a user through the input unit 110. The start time and the end time of the simulation period are defined as t^{s} and t^{f}, respectively.

Next, in step S200, the performance data extraction unit 131 extracts production performance data of a job group processed during the simulation period from the production performance data table 210. Hereinafter, the production performance data extracted by the present processing will be referred to as target performance data.

Step S300 is processing executed by the simulation execution unit 134 and the simulation error calculation unit 135. The simulation execution unit 134 executes a simulation of a simulation period from t^{s} to t^{f} using the information stored in the storage unit 120 and the target performance data described above. The simulation error calculation unit 135 calculates the simulation error by comparing the simulation result with the target performance data. Hereinafter, the simulation model for the simulation of the period from t^{s} to t^{f} is referred to as a whole simulation model M_{whole}.

When the simulation is executed, it is necessary to identify a state (hereinafter referred to as an initial state) of a production line at the simulation start time t^{s}. Here, the state of the production line represents information on the job group waiting for the processing of the process, information on the job group during the processing of the process, and information on assigned apparatuses and operators. These pieces of information can be identified based on the target performance data described above. When the simulation is executed, information on the job to be input to the production line during the simulation period from t^{s} to t^{f} and an input time thereof are required. These pieces of information can also be identified based on the target performance data described above.

In the present embodiment, a simulation error E is calculated according to the following equation 1.

$$\begin{matrix}[ Math 1 ] & \\ E = \frac{1}{{N}^{task}} {\sum }_{k = 1}^{{N}^{task}} {( {t}_{k}^{act} - {t}_{k}^{sim} )}^{2} & Equation 1\end{matrix}$$

Here, N^{task} represents a total number of tasks in the simulation. And, t^{act}ₖ and t^{sim}ₖ represent completion times in a performance and the simulation of a k-th task, respectively. Hereinafter, an error of the whole simulation is referred to as E_{whole}.

Steps S400 to S500 are processing executed by the simulation model division unit 132. In the present embodiment, the simulation model division unit 132 divides the whole simulation model into two stages from a time viewpoint and a production resource viewpoint to obtain a plurality of sub-models.

Hereinafter, model division processing from the time viewpoint will be described. First, in step S400, the simulation model division unit 132 acquires a time viewpoint division number N^{T} of the simulation model through the input unit. Next, in step S500, the simulation model division unit 132 divides the simulation period from t^{s} to t^{f} into N^{T} pieces.

A method for division is not limited. Here, the start time and the end time of each divided period are defined as t^{s}ᵢ and t^{f}ᵢ (i=1, 2, . . . , N^{T}), respectively, and a model for simulating a period from t^{s}ᵢ to t^{f}ᵢ is defined as a sub-model Mᵢ. By such division, each sub-model targets only a part of the tasks of the whole simulation.

Specifically, the sub-model Mᵢ targets only the task processed in the period from t^{s}ᵢ to t^{f}ᵢ on the target performance data. The information on the initial state of the production line at the simulation start time t^{s}ᵢ and the information on the job input to the production line in the period from t^{s}ᵢ to t^{f}ᵢ and the input time thereof can be identified based on the target performance data. Therefore, the simulation of each sub-model can be executed independently, and the sub-model having a large simulation error can be identified.

Next, division processing from the production resource viewpoint will be described. In the present processing, each sub-model obtained by the model division from the time viewpoint described above is further divided into a plurality of sub-models from the production resource viewpoint. A simulation model obtained by dividing the sub-model Mᵢ from the production resource viewpoint is referred to as a sub-model M_{i,j} (j=1, 2, . . . , N^{R}ᵢ, in which N^{R}ᵢ is a division number).

Here, at the time of the division, the simulation model division unit 132 divides the sub-model such that the plurality of sub-models do not share the production resources with each other. In the present embodiment, two division methods of a process data reference division and a production performance data reference division will be described.

In the process data reference division, the simulation model division unit 132 first obtains a process group targeted by the sub-model from a task group targeted by the sub-model Mᵢ. Next, the simulation model division unit 132 divides the process group into a plurality of sub-process groups. At this time, any process X and any process Y belonging to a sub-process group different from that of the process X define the sub-process group such that an allocatable apparatus and an allocatable operator are not shared. Then, a simulation model targeting a j-th sub-process group is referred to as the sub-model M_{i,j}.

In the production performance data reference division, the simulation model division unit 132 divides the task group targeted by the sub-model Mᵢ into a plurality of sub-task groups. At this time, the sub-task group is defined such that the apparatus and the operator on the production performance data of any task X is different from the apparatus and the operator on the production performance data of any task Y belonging to the sub-task group different from that of the task X. Then, the simulation model targeting a j-th sub-task group is referred to as the sub-model M_{i,j}.

By the above division, the simulation of each sub-model M_{i,j} can be executed independently, and the sub-model having a large simulation error can be identified. Two methods of the process data reference division and the production performance data reference division may be switched by input executed by a user or may be automatically and separately executed, and a use form thereof is not particularly limited.

Step S600 is processing executed by the simulation execution unit 134 and the simulation error calculation unit 135. In step S600, the simulation execution unit 134 executes the simulation of each sub-model Mᵢ obtained by the division from the time viewpoint and each sub-model M_{i,j} obtained by the division from the production resource viewpoint.

In the sub-model, the job is input according to performance data to the process in which the process in a previous stage is not present or the task in which the task in the previous stage is not present. An allocation rule of the production resources (apparatus and operators) is adjusted as necessary such that the production resources (apparatus and operators) are not shared among the sub-models in the production performance data reference division.

The simulation error calculation unit 135 calculates errors Eᵢ, E_{i,j} of each sub-model according to the equation 1, and stores a calculation result in the simulation result data table 280.

Step S700 is processing executed by the performance reflection unit 133. The present processing reflects the information extracted from the production performance data table 210 to elements such as the process time and the production control rule of each sub-model, and generates a new sub-model group. In the present embodiment, an example of a method for reflecting the performances will be described for the process time, the construction start order rule, the apparatus allocation rule, and the operator allocation rule. For example, Elements reflecting performance information may be determined by a design or according to a user designation.

Regarding the process time, the performance reflection unit 133 calculates time of a process start time to a process completion time of the production performance data as the process time of each task, and reflects the process time in the simulation model. That is, in the newly generated sub-model, the performance reflection unit 133 uses the process time of each task calculated according to the method described above without using the process time information defined in the production process data table 220.

Regarding the construction start order rule, the performance reflection unit 133 acquires a processing order of each task in each apparatus from the production performance data table 210, and reflects the processing order in the simulation model. That is, in the newly generated sub-model, when the next task to be processed is selected from processing waiting task groups of a certain apparatus, the performance reflection unit 133 selects a task having the earliest performance processing order described above from the task groups waiting for the processing, without using the rule defined in the construction start order rule model data table 250.

Regarding the apparatus allocation rule, the performance reflection unit 133 acquires an allocation apparatus for each task based on the production performance data table 210, and reflects the allocation apparatus in the simulation model. That is, in the newly generated sub-model, when the allocation apparatus for a certain task is selected, the performance reflection unit 133 selects a performance allocation apparatus for the task without using the rule defined in the apparatus allocation rule data table 260. The operator allocation rule is the same as the apparatus allocation rule.

In the processing in step S700, a new sub-model group is created by switching between a case in which the performance is reflected and a case in which the performance is not reflected for each of the process time, the construction start order rule, the apparatus allocation rule, and the operator allocation rule of each sub-model. Hereinafter, the sub-model newly created by reflecting the performance information in the sub-model M_{i,j} is referred to as a sub-model M^{a,b,c,d}_{i,j}. Here, a, b, c, and d are 0 or 1 indicating whether the performance is reflected for each of the process time, the construction start order rule, the apparatus allocation rule, and the operator allocation rule, respectively, and 1 means that the performance is reflected.

For example, M^{1,0,0,0}_{i,j} represents a model in which the performance is reflected only for the process time in the sub-model M_{i,j}, and M^{0,0,0,0}_{i,j} is synonymous with M_{i,j}. By comparing the errors of the plurality of sub-models M^{a,b,c,d}_{i,j} obtained according to the above, it is possible to identify a factor having a large influence on the error. For example, when an error of M^{0,1,1,1}_{i,j} is larger than an error of M^{1,1,1,1}_{i,j,} it can be interpreted that one of main causes of the error in M_{i,j} is the process time.

Step S800 is processing executed by the simulation execution unit 134 and the simulation error calculation unit 135. In step S800, the simulation execution unit 134 executes the simulation of each sub-model described above. The simulation error calculation unit 135 calculates an error E^{a,b,c,d}_{i,j} of each sub-model according to the equation 1, and stores a calculation result in the simulation result data table 280.

The division of the whole simulation model from the time viewpoint and/or the division of the whole simulation model from the production resource viewpoint may be omitted. The performance information may be reflected in the whole simulation model to generate a new whole simulation model, or may be reflected in the sub-model Mᵢ from the time viewpoint to generate a new sub-model.

The generation of the new whole simulation model or the new sub-model caused by reflecting the performance information in the whole simulation model or the sub-model may be omitted. The processing in S600 or S700 for a specific type of sub-model may be omitted. For example, the processing in S600 for the sub-model of the process data reference division may be omitted, and the processing in S700 and S800 may be executed.

As described above, by calculating the error between the production performance and the simulation result, the error factor can be identified, and a highly accurate production simulation can be implemented. Accordingly, feasibility and optimality of the production plan can be improved by planning the production plan using the production simulation. As in a time viewpoint division, a production resource viewpoint division, and a production performance reflection, by using the production performance instead of a part of information that is estimatable in the simulation during the simulation period, an element having a large influence on the error can be more easily identified.

As in the time viewpoint division and the production resource viewpoint division, the production simulation model is divided into the plurality of sub-models capable of executing the simulation independently of each other, and the simulation error is evaluated for each sub-model, whereby the sub-model having a large error can be identified. A new model group can be generated by reflecting the information extracted from the production performance data to model elements such as the process time and the production control rule in the whole simulation model or the sub-model, and a model element having a large influence on the error can be identified by comparing the errors between the case in which the production performance information is reflected and the case in which the production performance information is not reflected.

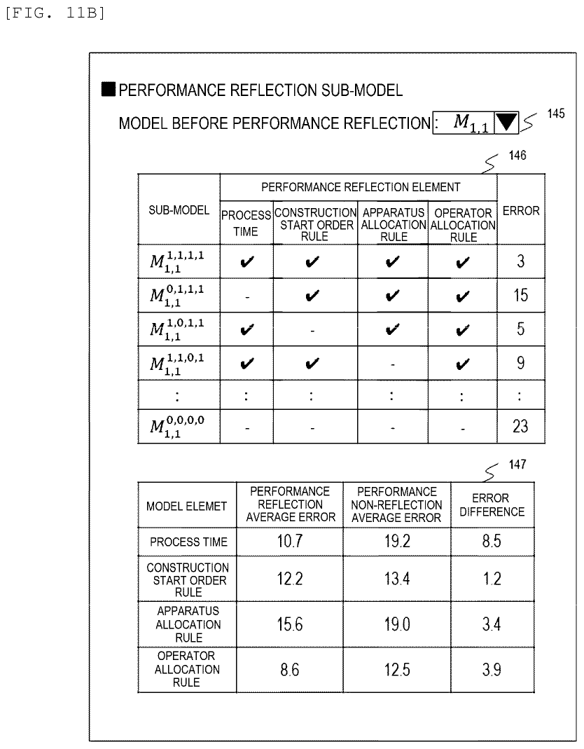

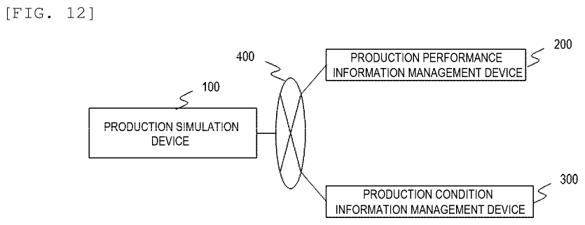

FIGS. 11A and 11B show an example of the display screen of the display unit 140 for information in the storage unit 120. FIGS. 11A and 11B each show a portion of one display screen. As shown in FIG. 11A, the screen displayed by the display unit 140 includes, for example, a whole simulation result display region 141, a time viewpoint division sub-model simulation result display region 142, a model selection region before division 143, and a production resource viewpoint division sub-model simulation result display region 144. As shown in FIG. 11B, the screen further includes, for example, a model selection region before performance reflection 145, a performance reflection sub-model simulation result display region 146, and an evaluation result display region for each model element 147.

In the whole simulation result display region 141, the simulation result of the whole simulation model M_{whole} is displayed. In the time viewpoint division sub-model simulation result display region 142, the simulation results of each sub-model Mᵢ obtained by division from the time viewpoint are displayed. In the production resource viewpoint division sub-model simulation result display region 144, the simulation results of the sub-model M_{i,j} obtained by dividing the sub-model Mᵢ selected in the model selection region before division 143 from the production resource viewpoint are displayed.

In the performance reflection sub-model simulation result display region 146, the simulation results of the sub-model M^{a,b,c,d}_{i,j} reflecting the performance information in the sub-model M_{i,j} selected in the model selection region before performance reflection 145 are displayed. In the evaluation result display region for each model element, information indicating a degree of influence on the simulation error of each model element such as the process time is displayed.

For example, in the example shown in FIG. 11B, comparison results of errors between the case in which the performance is reflected in each model element of the sub-model M_{i,j} and the case in which the performance is not reflected are displayed. Here, for example, a “performance reflection average error” and a “performance non-reflection average error” in a “process time” row of the evaluation result display region for each model element 147 in FIG. 11B are values calculated according to the following equations 2 and 3, respectively.

$$\begin{matrix}[ Math 2 ] & \\ \begin{matrix}performance reflection average error = \frac{1}{8} {\sum }_{b ∈ \{ 0 , 1 \}} {\sum }_{c ∈ \{ 0 , 1 \}} {\sum }_{d ∈ \{ 0 , 1 \}} {E}_{i , j}^{1 , b , c , d} & \end{matrix} & Equation 2\end{matrix}$$

$$\begin{matrix}[ Math 3 ] & \\ \begin{matrix}performance non - reflection average error = \frac{1}{8} {\sum }_{b ∈ \{ 0 , 1 \}} {\sum }_{c ∈ \{ 0 , 1 \}} {\sum }_{d ∈ \{ 0 , 1 \}} {E}_{i , j}^{0 , b , c , d} & \end{matrix} & Equation 3\end{matrix}$$

That is, the performance reflection (non-reflection) average error represents an average value of the errors of all the sub-models that reflect (do not reflect) the performance information to the target model element. A comparison of the two average error values is useful for identifying the element that has a large influence on the error of the sub-model M_{i,j}.

FIG. 12 is a schematic diagram of a production simulation system according to the present embodiment. As illustrated in the drawing, the production simulation system includes a production simulation device 100, a production performance information management device 200, and a production condition information management device 300, and these devices can transmit and receive information via a network 400. The production performance information management device 200 transmits the production performance data to the production simulation device 100. The production condition information management device 300 transmits process data, production resource data, production control rule data, and the like to the production simulation device 100.

The invention is not limited to the embodiments described above and includes various modifications. For example, the embodiments described above have been described in detail for easy understanding of the invention, and the invention is not necessarily limited to those including all the configurations described above. A part of the configuration according to one embodiment can be replaced with the configuration according to another embodiment, and the configuration according to one embodiment can be added with the configuration according to another embodiment. A part of the configuration according to each embodiment can be added, deleted, or replaced with other configurations.

The above-described configurations, functions, processing units, or the like described above may be implemented by hardware by designing a part or all of the configurations, functions, processing units, or the like with, for example, an integrated circuit. The above-described configurations, functions, or the like may also be implemented by software by a processor interpreting and executing a program for implementing the functions. Information of programs, tables, files or the like for implementing each function can be stored in a recording device such as a memory, a hard disk, and a solid-state drive (SSD), or a recording medium such as an IC card and an SD card. Control lines and information lines are those that are considered necessary for the description, and not all the control lines and the information lines on the product are necessarily shown. In practice, it may be considered that almost all configurations are connected to each other.

1. A production simulation device configured to estimate a progress of a process in a production line, the production simulation device comprising:
one or more processors; and
one or more storage devices, wherein
the one or more storage devices are configured to store
production performance information including information on a performance start time and a performance completion time of each process of a production job, and
a simulation model including information on a process time of each process, a production resource group that is allocatable to each process, an operating time of each production resource of each production resource group, and a production control rule of the production line, and
the one or more processors are configured to
execute a simulation using the production performance information and the simulation model, and
calculate a simulation error by comparing the production performance information with a result of the simulation.

2. The production simulation device according to claim 1, wherein
the one or more processors are configured to use information extracted from the production performance information instead of a part of information that is estimatable in the simulation.

3. The production simulation device according to claim 1, wherein
the one or more processors are configured to
divide the simulation model into a plurality of sub-models that are executable independently of each other,
execute a simulation using each of the plurality of sub-models, and
calculate the simulation error by comparing the production performance information with a result of each of the plurality of sub-models.

4. The production simulation device according to claim 3, wherein
a process of the production job constitutes a task,
the plurality of sub-models target each of a plurality of sub-task groups, and
a production resource in the production performance information on any task in the plurality of sub-task groups is different from a production resource in the production performance information on any task in a sub-task group different from that of the former task.

5. The production simulation device according to claim 3, wherein
the plurality of sub-models target each of a plurality of sub-process groups, and
a production resource that is allocatable in the simulation model in any process in the plurality of sub-process groups is different from a production resource that is allocatable in the simulation model in any process in a sub-process group different from that of the former process.

6. The production simulation device according to claim 3, wherein
each of the plurality of sub-models targets a period obtained by dividing a simulation period of the simulation model.

7. The production simulation device according to claim 1, wherein
the one or more processors are configured to
generate a plurality of new simulation models by reflecting information extracted from the production performance information to at least a part of a process time, an allocatable production resource group, an operating time of the allocatable production resource, and a production control rule in the simulation model, and
calculate the simulation error by comparing the production performance information with a simulation result of each of the plurality of new simulation models.

8. The production simulation device according to claim 1, wherein
the one or more processors are configured to display the simulation error.

9. A production simulation method executed by a device configured to estimate a progress of a process in a production line, wherein
the device is configured to store
production performance information including information on a performance start time and a performance completion time of each process of a production job, and
a simulation model including information on a process time of each process, a production resource group that is allocatable to each process, an operating time of each production resource of each production resource group, and a production control rule of the production line,
the method comprising:
executing, by the device, a simulation using the production performance information and the simulation model; and
calculating, by the device, a simulation error by comparing the production performance information with a result of the simulation.
